(19) United States
(12) Patent Application Publication
(10) Pub. No.: US 2010/0265399 A1
(43) Pub. Date: Oct. 21, 2010

(54) VIDEO/AUDIO INPUT/OUTPUT SYSTEM

(75) Inventors: Shigeru INOUE, Tokyo (JP); Takao Sasamura, Kanagawa (JP); Kojiro Kamizono, Kanagawa (JP); Ayataka Nishio, Kanagawa (JP); Takao Fukui, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/715,700

(22) Filed: Mar. 2, 2010

(30) Foreign Application Priority Data
Apr. 16, 2009 (JP) 2009-100133

(51) Int. Cl. H04N 5/04

(52) U.S. Cl. 348/500; 348/E05.009

(57) ABSTRACT

Provided is a video/audio input/output system including a video/audio input system including a video input device and a plurality of audio input devices and a video/audio output system including a video output device having a display surface, the video output device being for outputting a video on the display surface based on a video signal obtained by the video input device, and a plurality of audio output devices respectively corresponding to the plurality of audio input devices. The plurality of audio output devices are each installed at a location determined by decreasing or increasing, according to a reduction rate or an enlargement rate of the video to a real size and with a centre of the video as a reference, a distance from the centre of the video to a foot of a perpendicular drawn from the location of installation of the corresponding audio input device to the display surface, and the plurality of audio output devices output audio based on the audio signals obtained by the corresponding audio input devices.

### BACKGROUND OF THE INVENTION

1. Field of the Invention

The present invention relates to a video/audio input/output system.

2. Description of the Related Art

Generally, to convey what is going on at a concert hall or a site where a sport event is being held where a large audience gathers, a video obtained by filming the inside of the venue and audio collected and obtained at the venue is used. A viewer can grasp what is going on at the venue by listening to the obtained audio while viewing the obtained video.

For example, a technology for outputting the audio to be listened to by the viewer uses stereo, 5.1-channel surround, 6.1-channel surround, 7.1-channel surround, or the like. According to such technology, the viewer can listen to the audio, feeling as if he/she is actually at the venue. Various other technologies for outputting the audio are disclosed (for example, see JP2007-208318A).

### SUMMARY OF THE INVENTION

However, according to the technology as described above, it has been difficult to localize a sound image to a video. By listening to the audio output from a video while viewing the video, a viewer who is not actually at the venue can feel with realism what is going on at the venue. If the audio output at the time is matched with the video, the viewer can feel what is going on at the venue with more realism. To achieve this, it is important to localize the sound image to the video.

Thus, in light of the foregoing, it is desirable to provide a novel and improved technology enabling a user to feel with realism what is going on at a site where filming and sound-collecting are performed by listening to the collected audio while viewing the filmed video.

According to an embodiment of the present invention, there is provided a video/audio input/output system including a video/audio input system including a video input device for obtaining a video by filming in a specific direction under a specific magnification, for converting the obtained video to an electric signal, and for obtaining as a video signal the electric signal which has been converted, and a plurality of audio input devices installed at a plurality of points differing in horizontal distance from a point of installation of the video input device and in height, the plurality of audio input devices being for detecting surrounding vibrations, for converting the detected vibrations to electric signals, and for obtaining as audio signals the electric signals which have been converted, and a video/audio output system including a video output device having a display surface, the video output device being for outputting a video on the display surface based on the video signal obtained by the video input device, and a plurality of audio output devices respectively corresponding to the plurality of audio input devices. The plurality of audio output devices are each installed at a location determined by decreasing or increasing, according to a reduction rate or an enlargement rate of the video to a real size and with a centre of the video as a reference, a distance from the centre of the video to a foot of a perpendicular drawn from the location of installation of the corresponding audio input device to the display surface, and the plurality of audio output devices output audio based on the audio signals obtained by the corresponding audio input devices.

The plurality of audio output devices may be installed in directions that allow output of the audio towards the centre of the video.

The video/audio output system may further include an output control device for delaying timings of output of the audio by times corresponding to distances between a specific point and the locations of installation of the plurality of audio input devices and for making the corresponding plurality of audio output devices output the audio.

The video/audio output system may further include an output control device for making volumes of the audio smaller by volume reduction amounts corresponding to distances between a specific point and the locations of installation of the plurality of audio input devices and for making the corresponding plurality of audio output devices output the audio.

The specific point may be a point shown at the centre of the video.

The video/audio input system may further include an input control device for generating an audio/video signal by combining the video signal obtained by the video input device and each of the audio signals obtained by the plurality of audio input devices and for recording the generated audio/video signal on a recording medium, the video/audio output system may further include an output control device for reading the audio/video signal recorded on the recording medium, for extracting each of the audio signals and the video signal from the audio/video signal which has been read, and for outputting the extracted video signal to the video output device while outputting each of the extracted audio signals to the respective audio output devices corresponding to the respective audio input devices from which the audio signals have been obtained, the video output device may output the video on the display surface based on the video signal output by the output control device, and the plurality of audio output devices may output the audio based on the audio signals output by the output control device.

The video/audio input system may further include an input control device for generating an audio/video signal by combining the video signal obtained by the video input device and each of the audio signals obtained by the plurality of audio input devices and for transmitting the generated video/audio signal to the video/audio output system, the video/audio output system may further include an output control device for receiving the audio/video signal transmitted from the video/audio input system, for extracting each of the audio signals and the video signal from the audio/video signal which has been received, and for outputting the extracted video signal to the video output device while outputting each of the extracted audio signals to the respective audio output devices corresponding to the respective audio input devices from which the audio signals have been obtained, the video output device may output the video on the display surface based on the video signal output by the output control device, and the plurality of audio output devices may output the audio based on the audio signals output by the output control device.

According to the embodiments of the present invention described above, a viewer is enabled to feel with realism what is going on at a site where filming and sound-collecting are performed by listening to the collected audio while viewing the filmed video.

### BRIEF DESCRIPTION OF THE DRAWINGS

FIG. 1 is a configuration diagram of a video/audio input/output system according to a present embodiment;

FIG. 2 is a diagram showing an example of how audio input devices are installed;

FIG. 3 is a diagram showing an example of how audio output devices are installed;

FIG. 4 is a diagram for describing the calculation of volume and delay time of output audio;

FIG. 5 is a diagram showing a correspondence relationship between the distance from a reference point and the degree of distance attenuation (volume reduction amount);

FIG. 6 is a diagram showing a correspondence relationship between the distance from a reference point and a delay compensation amount (delay time); and

FIG. 7 is a diagram showing a relationship between virtual and actual locations of installation of a centre microphone.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted. Moreover, explanation will be given in the order shown below.

1. First Embodiment
1-1. Configuration of Video/Audio Input/Output System
1-2. Configuration of Video/Audio Input System
1-3. Configuration of Video/Audio Output System
1-4. Calculation of Volume and Delay Time of Output Audio

2. Modified Example of First Embodiment

3. Conclusion

### 1. FIRST EMBODIMENT

A first embodiment of the present invention will be described.

(1-1. Configuration of Video/Audio Input/Output System)

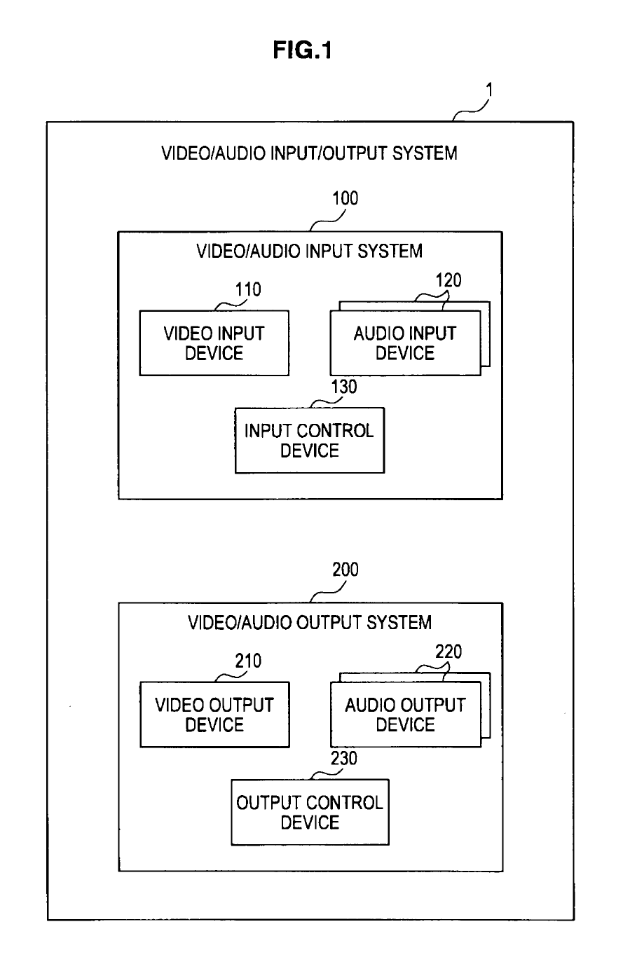

FIG. 1 is a configuration diagram of a video/audio input/output system according to the present embodiment. As shown in FIG. 1, a video/audio input/output system 1 according to the present embodiment includes a video/audio input system 100 and a video/audio output system 200. The video/audio input system 100 is a system which is installed at a concert hall, a site where a sport event is to be held, or the like, where a large audience will gather, for example. However, the site at which the video/audio input system 100 is to be installed is not limited to these venues, and may be any site at which a video and audio to be viewed and listened to by a viewer can be obtained.

The video/audio output system 200 is a system used for letting a viewer view and listen to the video and audio obtained by the video/audio input system 100. For example, a case is assumed where viewers who could not go to the venue or could not enter the venue gather at a location away from the venue and the gathered viewers view together what is going on at the venue. Accordingly, the video/audio output system 200 is assumed to be installed at a location away from the venue at which the video/audio input system 100 is installed. For example, when the number of viewers is more than a thousand, the video/audio output system 200 is assumed to be installed in a spacious field. However, when the number of viewers is down to several people, the video/audio output system 200 is assumed to be installed in a small space such as the home of an individual viewer.

(1-2. Configuration of Video/Audio Input System)

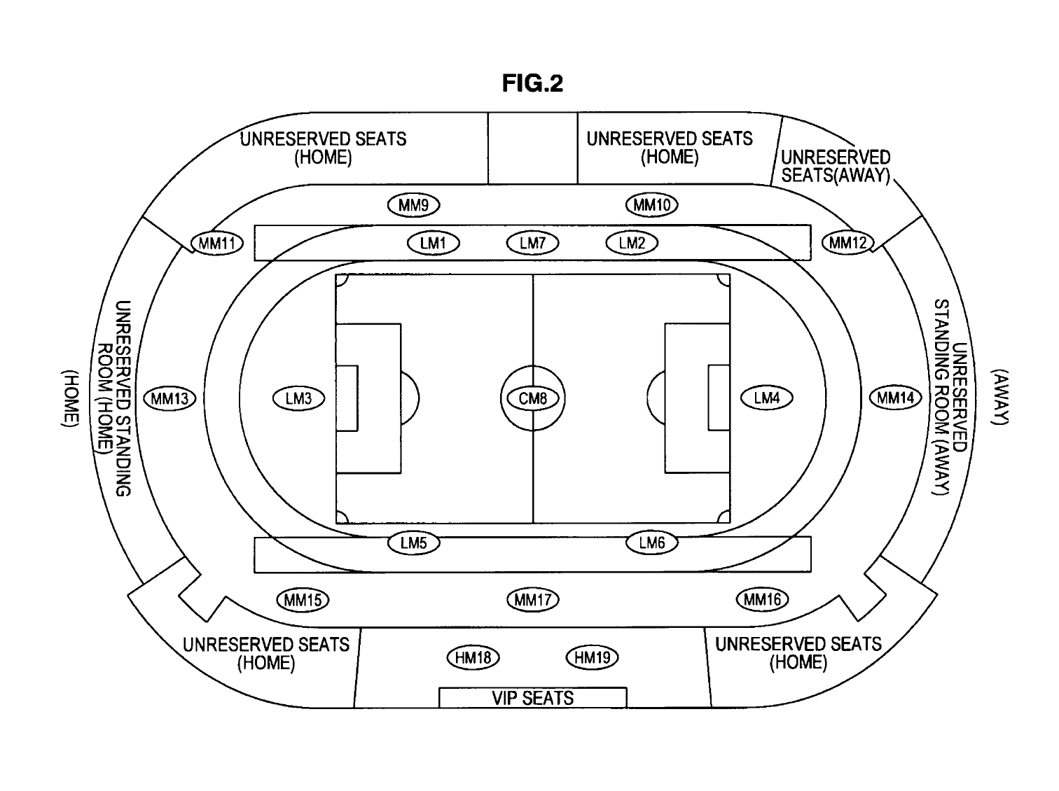

The video/audio input system 100 includes at least a video input device 110 and a plurality of audio input devices 120. Hereunder, each device configuring the video/audio input system 100 will be described with reference to FIGS. 1 and 2.

FIG. 2 is a diagram showing an example of how the audio input devices are installed. As shown in FIG. 2, the audio input devices 120 are installed at various locations in, for example, a football field, as low microphones LM1 to LM7, a centre microphone CM8, middle microphones MM9 to MM17, and high microphones HM18 and HM19. In the example shown in FIG. 2, the low microphones LM1 to LM7 and the centre microphone CM8 are installed at a pitch level (low level), the middle microphones MM9 to MM17 are installed at a stands level (middle level), and the high microphones HM18 and HM19 are installed at a ceiling level (high level). That is, sound collection is realized which uses total 19 channels: 8-channel surround in the pitch level (low level), 9-channel surround in the stands level (middle level) and 2-channel stereo in the ceiling level (high level).

The pitch level (low level), the stands level (middle level) and the ceiling level (high level) differ from each other in altitude. By reproducing audio collected at three levels, i.e. the pitch level (low level), the stands level (middle level) and the ceiling level (high level), the situation of a game being played on the football field can be reproduced with realism. Although the number of the levels is three in the example shown in FIG. 2, the number of the levels is not limited to such, and may be any number as long as it is more than one. Also, it suffices that more than one microphone is set in each level. Additionally, to prevent interference with the game, the centre microphone CM8 is realized by configuring the centre microphone CM8 from a parabola antenna or the like and hanging the parabola antenna from a distance.

We return to FIG. 1 to continue with the explanation. The video input device 110 obtains a video by filming in a specific direction under a specific magnification, converts the obtained video to an electric signal, and obtains as a video signal the electric signal which has been converted. The specific direction is not particularly limited, and can be freely determined to be a direction desirable to a viewer who will be viewing the video filmed by the video input device 110. Also, the specific magnification is not particularly limited, and can be freely determined to be a magnification desirable to a viewer who will be viewing the video filmed by the video input device 110. However, the video input device 110 is to film in a specific direction under a specific magnification, and thus, a video fixedly filming a specific area is obtained. The location at which the video input device 110 is to be installed is not particularly limited, and can be freely determined to be a location desirable to a viewer who will be viewing the video filmed by the video input device 110. For example, the video input device 110 can be installed in front of VIP seats. The video input device 110 is configured from a camera or the like, for example.

The plurality of audio input devices 120 are installed at a plurality of points differing in horizontal distance from the point of installation of the video input device 110 and in height, and the plurality of audio input devices 120 detect surrounding vibrations, convert the detected vibrations to electric signals, and obtain as audio signals the electric signals which have been converted. The surrounding vibration is a vibration of a medium (for example, air) adjacent to the audio input device 120, for example. The audio input device 120 is configured from a microphone or the like, for example. In the example shown in FIG. 2, the low microphones LM1 to LM7 and the centre microphone CM8, the middle microphones MM9 to MM17, and the high microphones HM18 and HM19 are installed at different altitudes. Also, in the example shown in FIG. 2, the microphones (low microphones LM1 to LM7, centre microphone CM8, middle microphone MM9 to MM17, and high microphones HM18 and HM19) are installed at a plurality of points mutually different in the horizontal distance from the location at which the video input device 110 is installed (for example, in front of the VIP seats).

(1-3. Configuration of Video/Audio Output System)

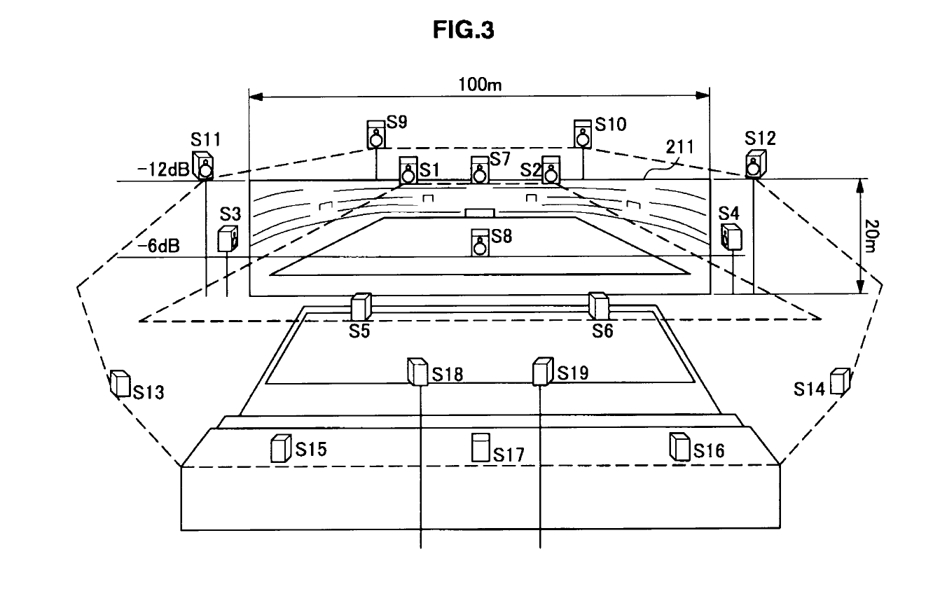

The video/audio output system 200 includes at least a video output device 210 and a plurality of audio output devices 220. Hereunder, each device configuring the video/audio output system 200 will be described with reference to FIGS. 1 and 3.

FIG. 3 is a diagram showing an example of how the audio output devices are installed. As shown in FIG. 3, the audio output devices 220 are installed, as speakers S1 to S19, within a display surface 211 of the video output device 210 or at extensions of the display surface 211. In the example shown in FIG. 3, the speaker S8 is installed within the display surface 211, and other speakers S1 to S7 and S9 to S19 are installed at the extensions of the display surface 211. The speaker S8 is installed in accordance with the location of the centre microphone CM8 appearing in the video displayed on the display surface 211. In a similar manner, the speakers S1 to S7 and S9 to S19 are installed in accordance with the locations of respective microphones (low microphones LM1 to LM7, middle microphones MM9 to MM17, and high microphones HM18 and HM19) appearing in the video displayed on the display surface 211 when it is assumed that the filmed area extends infinitely. Although the size of the display surface (screen) 211 is 100 m in width and 20 m in height in the example shown in FIG. 3, the size is not limited to such. Also, in the example shown in FIG. 3, the audio output devices 220 (speakers S1 to S19) are installed in the direction that allows output of audio towards the centre of the video displayed on the display surface 211.

We return to FIG. 1 to continue with the explanation. The video output device 210 includes the display surface 211, and outputs video on the display surface 211 based on a video signal obtained by the video input device 110. The video output device 210 is configured from, for example, a display device such as a large screen or a television, but the type of the video output device 210 is not particularly limited.

The plurality of audio output devices 220 respectively correspond to the plurality of audio input devices 120. The plurality of audio output devices 220 are each installed at a location determined by decreasing or increasing, according to the reduction rate or enlargement rate of the video to the real size and with the centre of the video as the reference, the distance from the centre of the video to the foot of a perpendicular drawn from the location of installation of the corresponding audio input device 120 to the display surface 211. It should be noted that each of the points of installation of the plurality of audio input devices 120, which is the starting point of the perpendicular, indicates each of the points at which the plurality of audio input devices 120 are virtually installed so as to encircle the display surface 211. That is, each of the points is taken to be each of the locations after movement and rotation of the plurality of audio input devices 120 that are determined when it is assumed that the video input device 110 is moved to the middle point of the display surface 211 and the audio input devices 120 are appropriately rotated with the video input device 110 after movement as the reference while maintaining the location relationships between the plurality of audio input devices 120 and the video input device 110 that are actually installed and the directions thereof. The appropriate rotation is rotation which matches with the above-described specific direction the direction of the sight line of a viewer viewing the video displayed on the display surface 211 from an angle perpendicular to the display surface 211, for example. The audio output devices 220 output audio based on the audio signals obtained by corresponding audio input devices 120. The plurality of audio output devices 220 are configured from speakers, for example.

Furthermore, the plurality of audio output devices 220 may be installed in the directions that allow output of audio towards the centre of the video displayed on the display surface 211. According to such configuration, the video and the origins of the audio can be matched.

The video/audio output system 200 may also include an output control device 230. The output control device 230 is for delaying the timings of output of audio by times corresponding to the distances between a specific point and the locations of installation of the plurality of audio input devices 120 and for making the corresponding plurality of audio output devices 220 output the audio. The reason is that audio emitted at each location of installation of the audio input devices 120 arrives at the specific point, being more delayed as the distance from the location of installation of each of the plurality of audio input devices 120 to the specific point increases. Since the plurality of audio output devices 220 are installed within the display surface 211 or at the extensions of the display surface 211, the distance between the audio output device 220 and the viewer is practically the same for the plurality of audio output devices 220. Thus, it is enough that the output control device 230 adjusts the timings of output of audio. How much delay is to be caused will be described later. The specific point is not particularly limited, but may be a point shown at the centre of the video displayed on the display surface 211, for example. The video and the origins of the audio can be matched in this manner.

Also, the output control device 230 may make the volumes of audio smaller by the volume reduction amounts corresponding to the distances between a specific point and the locations of installation of the plurality of audio input devices 120 and make the corresponding plurality of audio output devices 220 output the audio. The reason is that audio emitted at each location of installation of the audio input devices 120 arrives at the specific point, being smaller in volume as the distance from the location of installation of each of the plurality of audio input devices 120 to the specific point increases. Since the plurality of audio output devices 220 are installed within the display surface 211 or at the extensions of the display surface 211, the distance between the audio output device 220 and the viewer is practically the same for the plurality of audio output devices 220. Thus, it is enough that the output control device 230 adjusts the volumes of audio to be output. How much smaller the volumes are to be will be described later. The specific point is not particularly limited, but may be a point shown at the centre of the video displayed on the display surface 211, for example. The video and the origins of the audio can be matched in this manner.

The video/audio input system 100 may also include an input control device 130. The input control device 130 is for generating an audio/video signal by combining a video signal obtained by the video input device 110 and each of the audio signals obtained by the plurality of audio input devices 120, and for recording the generated audio/video signal on a recording medium. The input control device 130 associates the time the video signal was obtained and the time each audio signal was obtained, and combines the video signal and each audio signal.

In case the video/audio input system 100 includes the input control device 130, the output control device 230 may read the audio/video signal recorded on the recording medium and extract each audio signal and the video signal from the audio/video signal which has been read. In this case, the output control device 230 may also output the extracted video signal to the video output device 210 while outputting each of the extracted audio signals to respective audio output devices 220 corresponding to respective audio input devices 120 from which the audio signals have been obtained. Furthermore, in this case, the video output device 210 may output video on the display surface 211 based on the video signal output by the output control device 230, and the plurality of audio output devices 220 may output audio based on the audio signals output by the output control device 230.

The video/audio input system 100 may include an input control device 130 having functions different from those of the input control device 130 described above. That is, the input control device 130 may generate an audio/video signal by combining a video signal obtained by the video input device 110 and each of the audio signals obtained by the plurality of audio input devices 120 and transmit the generated video/audio signal to the video/audio output system 200. The input control device 130 associates the time the video signal was obtained and the time each audio signal was obtained, and combines the video signal and each audio signal. For example, by configuring the input control device 130 and the output control device 230 so as to be capable of communication with each other, transmission and reception of information between the video/audio input system 100 and the video/audio output system 200 are enabled.

In case the video/audio input system 100 includes such input control device 130, the output control device 230 may receive the audio/video signal transmitted from the video/audio input system 100 and extract each audio signal and the video signal from the audio/video signal which has been received. In this case, the output control device 230 may also output the extracted video signal to the video output device 210 while outputting each of the extracted audio signals to respective audio output devices 220 corresponding to respective audio input devices 120 from which the audio signals have been obtained. Furthermore, in this case, the video output device 210 may output video on the display surface 211 based on the video signal output by the output control device 230, and the plurality of audio output devices 220 may output audio based on the audio signals output by the output control device 230.

(1-4. Calculation of Volume and Delay Time of Output Audio)

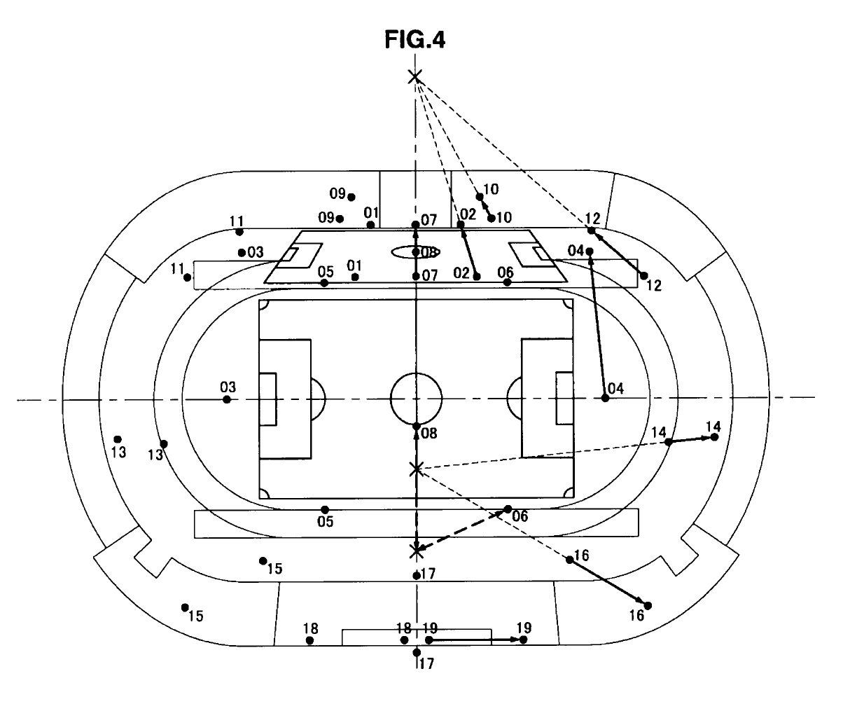

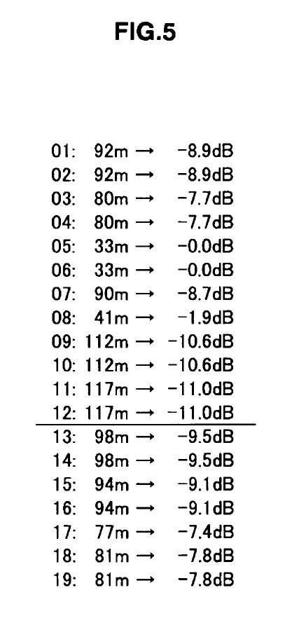

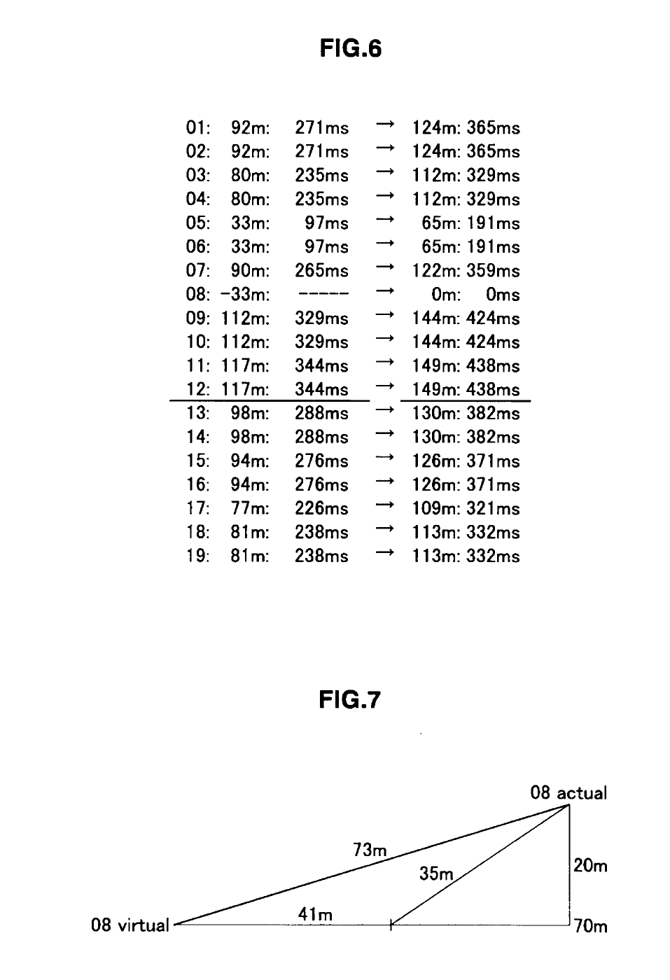

FIG. 4 is a diagram for describing the calculation of volume and delay time of output audio. FIG. 5 is a diagram showing a correspondence relationship between the distance from a reference point and the degree of distance attenuation (volume reduction amount). FIG. 6 is a diagram showing a correspondence relationship between the distance from a reference point and a delay compensation amount (delay time). FIG. 7 is a diagram showing a relationship between virtual and actual locations of installation of the centre microphone.

Hereunder, technologies for calculating the volume and the delay time of the audio to be output by the audio output device 220 will be described with reference to FIGS. 4 to 7. Moreover, in FIG. 4, the locations of the low microphones LM1 to LM7, the centre microphone CM8, the middle microphones MM9 to MM17, and the high microphones HM18 and HM19 will be respectively shown by numerals “01” to “19,” for the sake of convenience.

Furthermore, an explanation will be made here for a calculation example assuming a case of a small-scale SPV where the width of the display surface 211 (screen width) of the video output device 210 is 20 m or less and the audience (viewers) viewing the SPV (display surface 211 (screen) of the video output device 210) can fit into 20 square metres. However, the size of the display surface 211 of the video output device 210 and the number of the viewers are not limited to such.

In case of using the small-scale SPV as the display surface 211 of the video output device 210, the distance between each of the speakers S1 to S19 to the audience is less compared to the distances between the microphones (low microphones LM1 to LM7, centre microphone CM8, middle microphones MM9 to MM17, and high microphones HM18 and HM19) on the recording side, and thus, calculation is performed without taking into account the influence due to the difference in the existing locations of the speakers at the venue where the SPV is installed. Moreover, in case of using a large-scale SPV approximately equivalent to the life size, it suffices that the volume and the delay time of the output audio are calculated by subtracting therefrom, after performing the calculation shown below, the amounts of the volume and the delay time corresponding to the distance from the audience to the location at which actual speaker exists.

First, since two reference points and one reference length become necessary, the reference points which will be the reference for the calculation will be determined. One of the reference points is the middle point of the perpendicular drawn from the middle point of the line connecting the low microphone LM5 and the low microphone LM6 to the anterior edge of the lower stands, and this is made to be the reference for adjustment of the sound at the front part of the audience seats of the SPV. This point is made to be a reference point A. However, the location of the reference point A is not particularly limited.

Another reference point is the middle point of the perpendicular drawn from the centre of the display surface 211 (screen) to the middle microphone MM17 at the upper part of the stands, and this is made to be the reference for adjustment of the sound at the rear part of the audience seats of the SPV. This point is made to be a reference point B. However, the location of the reference point B is not particularly limited. The middle microphones MM13 and MM14 would be located at rather anterior part of the audience seats (display surface 211 (screen) side) of the SPV. However, the pitch where the players play is at the front screen (display surface 211 (screen) side), and thus the middle microphones MM13 and MM14 will be grouped as the sound at the rear part of the audience seats.

The reference point B corresponds to the centre of the actual viewing point. Moreover, the locations of the speakers S13 to S19 defined here are locations expedient in case of installing a stadium-scale life-sized SPV, and do not indicate the locations of the speakers S13 to S19 to be installed when using a small-sized SPV.

Next, a reference length which is to be the reference for the distance attenuation is calculated. The reference length is made to be the distance from the reference point A to the low microphone LM6 (or the low microphone LM5). When the distance from the line connecting the low microphone LM5 and the low microphone LM6 to the anterior edge of the lower stands is 28 m and the distance from the centre line to the low microphone LM6 is 30 m, the reference length can be calculated by the following formula (1).

√(14 m×14 m+30 m×30 m)=33 m (1)

However, the calculation method for the reference length is not limited to such method. Also, the reference length may be obtained by actually measuring the reference length.

Next, the distances from the reference point A to the low microphones LM1 to LM7, the centre microphone CM8 and the middle microphones MM9 to MM12, and the distances from the reference point B to the middle microphones MM13 to MM17 and the high microphones HM18 and HM19 are calculated or are actually measured, and thereby the distance attenuations (volume reduction amounts) and the delay compensation amounts (delay times) are calculated. Here, the distances from the reference point A to the low microphones LM1 to LM7, the centre microphone CM8 and the middle microphones MM9 to MM12 may be horizontal distances, but the distances from the reference point B to the middle microphones MM13 to MM17 and the high microphones HM18 and HM19 are obtained by calculating three-dimensionally, including height.

Accordingly, the audio at the anterior part of the pitch calculated based on the reference point A is localized at the rear part of the screen (display surface 211) by moving to a location centring around the reference point B, and a sound field auditorily matching the bird's-eye view displayed on the screen (display surface 211) can be formed. When each of the distances is taken as X, the distance attenuation (volume reduction amount) is derived from the following formula (2).

20×log(33 m/Xm)dB (2)

For example, the distance from the reference point A to the low microphone LM1 is 92 m, and thus, the distance attenuation (volume reduction amount) is calculated to be −8.9 dB by the above formula (2). In a similar manner, the delay compensation amount is derived from the following formula (3).

Xm/340 m/s×1000 ms/s (3)

(where the sound velocity is 340 m/s.)

For example, the distance from the reference point A to the low microphone LM1 is 92 m, and thus, the distance attenuation is calculated to be 271 ms by the above formula (3). First, compensation values of all the channels excluding the sound recorded by the centre microphone CM8 are calculated by the formula (3). Moreover, in case of an SPV not using the centre microphone CM8, the compensation values calculated here will be taken, as they are, as the delay compensation amounts.

The centre microphone CM8 is a parabolic antenna and it picks up the sound centring around the edge of the centre circle, and thus, a long space delay is included at the time of recording and the delay has to be inversely compensated for.

The virtual location (virtual 08) of the centre microphone CM8 is at a location 41 m away from the reference point A. However, since the actual location of the centre microphone CM8 is 73 m away from the virtual location, a compensation is performed by adding a negative delay amount equivalent to the difference, i.e. 32 m, to all the channels excluding the centre microphone CM8.

For example, although the distances from the reference point A to the low microphones LM1 to LM7 are 92 m, they are calculated to be 124 m by adding the inverse compensation amount, and thus, the distance attenuations will be 365 ms by the formula (3) shown above.

Moreover, in case of a large-scale SPV, since the microphones in the rear are nearer to the locations of the actual sound sources, the distance attenuation calculation and the delay compensation for the audio output from the speakers corresponding to the microphones are practically unnecessary, and the volume and the delay time of the audio output from the speakers can be calculated, in relation to the low microphones LM1 to LM7, the centre microphone CM8 and the middle microphones MM9 to M12, by merely subtracting therefrom the amounts of the volume and the delay time corresponding to the distance from the distance calculated above to the actual speaker installation location.

### 2. MODIFIED EXAMPLE OF FIRST EMBODIMENT

It should be understood by those skilled in the art that various modifications, combinations, sub-combinations and alterations may occur depending on design requirements and other factors insofar as they are within the scope of the appended claims or the equivalents thereof.

### 3. CONCLUSION

According to the present embodiment, a viewer can feel with realism what is going on at a site where filming and sound-collecting are performed by listening to the collected audio while viewing the filmed video.

The present application contains subject matter related to that disclosed in Japanese Priority Patent Application JP 2009-100133 filed in the Japan Patent Office on Apr. 16, 2009, the entire content of which is hereby incorporated by reference.

What is claimed is:

1. A video/audio input/output system comprising:
a video/audio input system including
a video input device for obtaining a video by filming in a specific direction under a specific magnification, for converting the obtained video to an electric signal, and for obtaining as a video signal the electric signal which has been converted, and
a plurality of audio input devices installed at a plurality of points differing in horizontal distance from a point of installation of the video input device and in height, the plurality of audio input devices being for detecting surrounding vibrations, for converting the detected vibrations to electric signals, and for obtaining as audio signals the electric signals which have been converted; and
a video/audio output system including
a video output device having a display surface, the video output device being for outputting a video on the display surface based on the video signal obtained by the video input device, and
a plurality of audio output devices respectively corresponding to the plurality of audio input devices,
wherein the plurality of audio output devices are each installed at a location determined by decreasing or increasing, according to a reduction rate or an enlargement rate of the video to a real size and with a centre of the video as a reference, a distance from the centre of the video to a foot of a perpendicular drawn from the location of installation of the corresponding audio input device to the display surface, and wherein the plurality of audio output devices output audio based on the audio signals obtained by the corresponding audio input devices.

2. The video/audio input/output system according to claim 1, wherein the plurality of audio output devices are installed in directions that allow output of the audio towards the centre of the video.

3. The video/audio input/output system according to claim 1, wherein the video/audio output system further includes an output control device for delaying timings of output of the audio by times corresponding to distances between a specific point and the locations of installation of the plurality of audio input devices and for making the corresponding plurality of audio output devices output the audio.

4. The video/audio input/output system according to claim 1, wherein the video/audio output system further includes an output control device for making volumes of the audio smaller by volume reduction amounts corresponding to distances between a specific point and the locations of installation of the plurality of audio input devices and for making the corresponding plurality of audio output devices output the audio.

5. The video/audio input/output system according to claim 3, wherein the specific point is a point shown at the centre of the video.

6. The video/audio input/output system according to claim 4, wherein the specific point is a point shown at the centre of the video.

7. The video/audio input/output system according to claim 1,
wherein the video/audio input system further includes an input control device for generating an audio/video signal by combining the video signal obtained by the video input device and each of the audio signals obtained by the plurality of audio input devices and for recording the generated audio/video signal on a recording medium,
wherein the video/audio output system further includes an output control device for reading the audio/video signal recorded on the recording medium, for extracting each of the audio signals and the video signal from the audio/video signal which has been read, and for outputting the extracted video signal to the video output device while outputting each of the extracted audio signals to the respective audio output devices corresponding to the respective audio input devices from which the audio signals have been obtained,
wherein the video output device outputs the video on the display surface based on the video signal output by the output control device, and
wherein the plurality of audio output devices output the audio based on the audio signals output by the output control device.

8. The video/audio input/output system according to claim 1,
wherein the video/audio input system further includes an input control device for generating an audio/video signal by combining the video signal obtained by the video input device and each of the audio signals obtained by the plurality of audio input devices and for transmitting the generated video/audio signal to the video/audio output system,
wherein the video/audio output system further includes an output control device for receiving the audio/video signal transmitted from the video/audio input system, for extracting each of the audio signals and the video signal from the audio/video signal which has been received, and for outputting the extracted video signal to the video output device while outputting each of the extracted audio signals to the respective audio output devices corresponding to the respective audio input devices from which the audio signals have been obtained,
wherein the video output device outputs the video on the display surface based on the video signal output by the output control device, and
wherein the plurality of audio output devices output the audio based on the audio signals output by the output control device.
